(19) United States
(12) Patent Application Publication
(10) Pub. No.: US 2006/0087180 A1
(43) Pub. Date: Apr. 27, 2006

(54) Bi-directional operating compressor using transverse flux linear motor

(75) Inventors: Byung-Chul Woo, Changwon-si (KR); Do-Hyun Kang, Changwon-si (KR); Jeong-Hwan Jang, Changwon-si (KR); Ji-Won Kim, Pusan-si (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTROTECHNOLOGY RESEARCH INSTITUTE

(21) Appl. No.: 11/171,269

(22) Filed: Jul. 1, 2005

(30) Foreign Application Priority Data
Oct. 22, 2004 (KR) 10-2004-0084891

(51) Int. Cl. H02K 41/00; H02K 35/00

(52) U.S. Cl. 310/12; 417/417; 310/15

(57) ABSTRACT

Disclosed herein is a bi-directional operating compressor using a transverse flux linear motor, the compressor comprising: a pair of stators including a plurality of U-shape upper stator iron cores and a plurality of U-shape lower stator iron cores, and a pair of neighboring circular winding coils; a rotor placed between the pair of stators including a plurality of permanent magnets connected to iron cores, a rotor center installed between a pair of structures facing each other, a pair of supports connected to both sides of the center, and a pair of pistons connected to one side of the support respectively; and a pair of cylinders provided facing the pistons at both side ends of the rotor, for compressing air in response to the reciprocating motion of the pistons.

### BACKGROUND OF THE INVENTION

1. Field of the Invention

The present invention relates to a high-power, high-efficiency linear power generating system. More specifically, the invention relates to a bi-directional operating compressor using a transverse flux linear motor having a simple structure with high output power, which can enhance efficiency of power generation.

2. Background of the Related Art

In general, in case of widely used refrigerators and air conditioners, a compressor is indispensable and functions converting low pressure steam into high pressure using the heat absorbed by an evaporator. For this compressor comprising a piston and a cylinder, a rotational motor using a reciprocating or a scrolling method is widely used, and, in order to generate a linear power, an operating system of a dual structure is used, which combines a rotational motor and an additional mechanical device which converts the rotating power into a linear motion. A ball screw or the like is used as a linear motion converting device, however the operating system of a dual structure has an intricate structure and high production costs together with high maintenance costs. Furthermore, the operating system of a dual structure is very noisy, inefficient, and voluminous.

On the other hand, differently from the rotational motor which needs a linear motion converting device, a linear motor having a simple structure does not need an additional mechanical device, however, the length is limited structurally, and thus an inlet end portion and an outlet end portion exist, so that leakage magnetic flux together with distortion and loss of energy is incurred, thereby deteriorating the efficiency. Furthermore, a large amount of permanent magnets are needed for high efficiency and high power, so that the volume of a motor and costs increase, thereby making it difficult to apply to a compressor. In a certain case, a compressor is applied to a linear motor, however, a conventional linear motor uses a perpendicular flux motor, and uni-directional operating motor are used generally.

In an example of a compressor using such a conventional linear motor, as shown in FIG. 1, the compressor comprises an upper and a lower stator 101, a cylinder 102 connected to one side of the stator, an outer iron core 103 connected to the other side of the stator and forming a motor generating a driving force, an inner iron core 104 inserted into the outer iron core 103 placing a gap and combined with the cylinder 102, a winding coil 105 winding the outer iron core 103, a permanent magnet 106 combined between the inner iron core 103 and the outer iron core 104 and performing a linear motion when the motor operates, a piston 107 inserted into the compressed space inside the cylinder 102, a connecting member 108 connecting the permanent magnet 106 to the piston 107 and transferring the linear motion of the permanent magnet 106 to the piston 107, a body cover 109 connected to one side of the stator 101 forming a certain moving space inside and covering the connecting member, and an inner and an outer spring 110, 111 inserted between the connecting member 108 and the cylinder 102, and between the connecting member 108 and the body cover 109 supporting the movement of the piston 107 elastically and storing the kinetic energy as well. When current is applied to the motor and the current flows through the winding coil 105, by a mutual interacting force of the flux which flows the inner iron core 103 and the outer iron core 104 by the current flowing through the winding coil and the flux which is generated by the permanent magnet 106, the permanent magnet 106 performs linear reciprocating motion, and the linear motion is transferred to the piston 107 via the connecting member 108. The piston 107 supported by the springs 110, 111 elastically performs linear reciprocating motion inside the cylinder 102.

A compressor using the linear motor operates uni-directionally by the perpendicular flux power, in which the moving direction of the piston 107 is same as the direction of the flux applied to the outer iron core 103 and the inner iron core 104 by the current flowing through the winding coil 105, therefore the compressor is relatively voluminous and inefficient compared with a bi-directional operating compressor of the same capacity.

### SUMMARY OF THE INVENTION

Therefore, the present invention has been made in view of the above problems occurring in the prior art, and it is an object of the present invention to provide a bi-directional operating compressor using a transverse flux linear motor, in which, contrary to a widely used rotational motor such as a reciprocating type motor which converts rotational motion into linear motion, a piston is directly applied to a compressor so as to be combined with a transverse flux linear motor performing linear reciprocating motion, and, contrary to a generally used linear compressor operated or rotated by one piston in one motor is a uni-directional operating type in general, pistons are placed at the left and right side of one transverse flux linear motor. That is, using a method of operating a transverse flux linear motor between pistons placed at both sides, a resonant mechanism is used, in which a spring absorbs and emits variable speed generated by compression and releases when the piston moves left and right, and a transverse flux linear motor in which the direction of the flux is transverse to the moving direction are used. Particularly, the capacity of a compressor which is indispensably used in a freezing machine can be controlled by adjusting the exact location and the torque value, and thus a transverse flux linear motor having superior thrust force characteristics per unit weight is applied.

To accomplish the above objects, according to the present invention, there is provided a bi-directional operating compressor using a transverse flux linear motor. The a bi-directional operating compressor of the invention includes: a pair of stators including a plurality of U-shape upper stator iron cores and a plurality of U-shape lower stator iron cores, the upper and lower stator cores being arranged in parallel at regular intervals respectively in such a manner that the individual stator iron cores are spaced apart from each other by a certain desired polar pitch, and the upper stator iron cores and the lower iron cores face each other and are offset by the polar pitch, and a pair of neighboring circular winding coils, both of the pillars of the stator iron core being inserted into the center of the winding coils; a rotor placed between the pair of stators, the rotor including a plurality of permanent magnets connected to iron cores of a certain length so as to generate fluxes of different directions, a rotor center installed between a pair of structures, the permanent magnets and the rotor iron cores being connected such that the structures are placed to face each other, a pair of supports connected to both sides of the center, and a pair of pistons connected to one side of the support respectively; and a pair of cylinders provided facing to the pistons at both side ends of the rotor, for compressing air in response to the reciprocating motion of the pistons.

In addition, the bi-directional operating compressor is characterized in that it further includes a spring, both ends of which are fixed to the support of the rotor and one side of the cylinder.

In addition, the bi-directional operating compressor is characterized in that the rotor has rectangular depressions formed at both portions adjacent to the center thereof.

In addition, the bi-directional operating compressor is characterized in that the operating axis of the piston at both ends of the rotor is eccentric with respect to the center axis.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows a cross-sectional view of a compressor using a conventional perpendicular flux linear motor;

FIG. 2 shows an exploded perspective view of a bi-directional operating compressor using a transverse flux linear motor according to the invention;

FIG. 3 shows an exploded perspective view of a rotor of the bi-directional operating compressor using a transverse flux linear motor according to the invention;

FIG. 4 shows a side view of the rotor of the bi-directional operating compressor using a transverse flux linear motor according to the invention;

FIG. 5 shows a perspective view of a stator iron core of the bi-directional operating compressor using a transverse flux linear motor according to the invention;

FIG. 6 shows a perspective view of a stator winding coil of the bi-directional operating compressor using a transverse flux linear motor according to the invention;

FIG. 7 shows a descriptive view of a right side operation of the bi-directional operating compressor using a transverse flux linear motor according to the invention;

FIG. 8 shows power generation principles of the right side operation of the bi-directional operating compressor using a transverse flux linear motor according to the invention;

FIG. 9 shows a descriptive view of a left side operation of the bi-directional operating compressor using a transverse flux linear motor according to the invention;

FIG. 10 shows power generation principles of the left side operation of the bi-directional operating compressor using a transverse flux linear motor according to the invention;

FIG. 11 shows a side view of a transverse flux linear motor having a plurality of rotor iron cores and stator iron cores according to the invention;

FIG. 12 shows a time-current characteristic graph of a rotor of the a transverse flux linear motor according to the invention;

FIG. 13 shows a time-generated thrust force characteristic graph of the rotor of a transverse flux linear motor according to the invention;

FIG. 14 shows a location-current characteristic graph of the rotor of a transverse flux linear motor according to the invention;

FIG. 15 shows a location-generated thrust force characteristic graph of the rotor of a transverse flux linear motor according to the invention;

FIG. 16 shows a current supply circuit diagram of a transverse flux linear motor according to the invention;

FIG. 17 shows a circuit diagram of a two-element parallel configuration of a transverse flux linear motor according to the invention;

FIG. 18 shows a circuit diagram of a series configuration of a transverse flux linear motor according to the invention;

FIG. 19 shows a circuit diagram of a four-element parallel configuration of a transverse flux linear motor according to the invention; and

FIG. 20 shows a descriptive view of a compressor formed with a bi-directional operating piston-resonant spring and a transverse flux linear motor according to the invention.

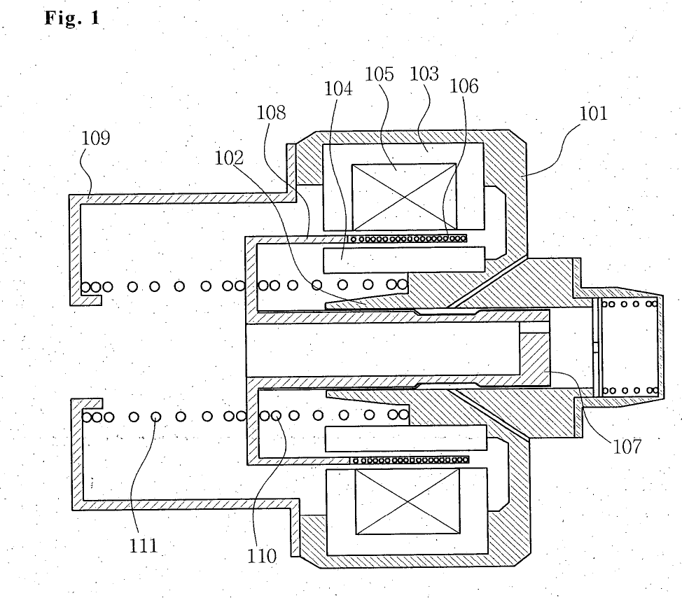

### DETAILED DESCRIPTION OF THE PREFERRED EMBODIMENT

The preferred embodiments of the invention will be hereafter described in detail, with reference to the accompanying drawings. It is noted that details on the well-known components and their functions will not be described herein.

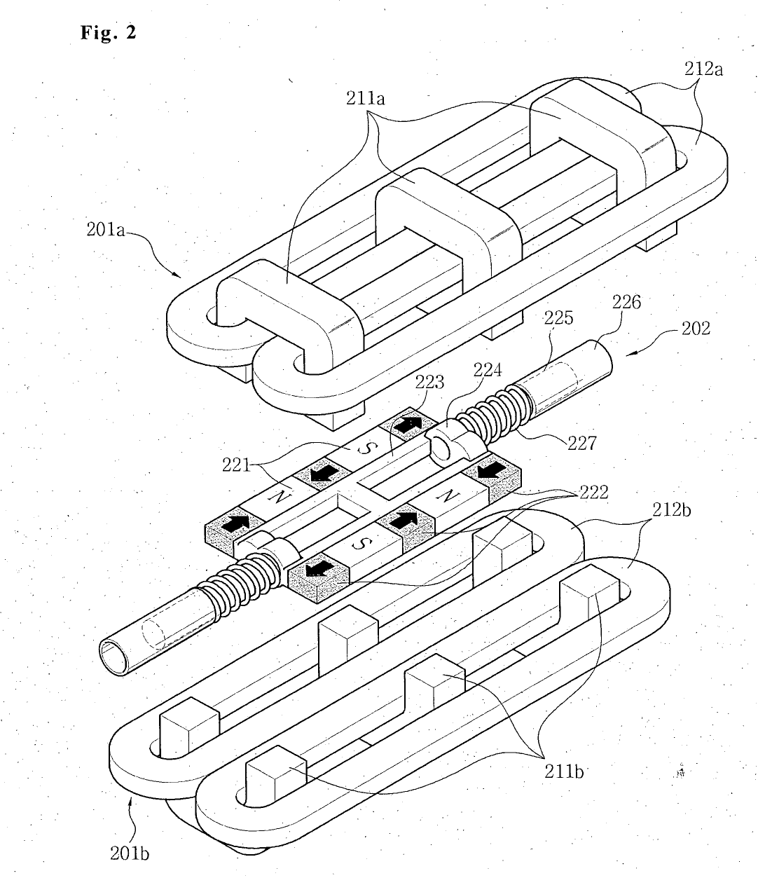

FIG. 2 shows an exploded perspective view of a bi-directional operating compressor using a transverse flux linear motor according to the invention.

As shown in FIG. 2, a pair of stators 201a, 201b are facing each other up-and-downwardly, each of which includes a plurality of U-shape stator iron cores 211a, 211b and a pair of neighboring circular cylinder type winding coils 212a, 212b which allow current to flow through the stators. A rotor 202 comprising rotor iron cores 221 and permanent magnets 222 having high energy density is placed between a pair of, i.e. the upper and the lower, stators 201a, 201b and is connected to resonant springs 227.

In addition, a pair of structures, in which a plurality of permanent magnets 222 are connected to rotor iron cores 221 having a certain length, the magnets being arranged in a way that different poles are facing each other so as to generate fluxes of different directions, are placed so as the different poles to face each other with a center 223 installed between the structures as a boundary, so that a force which enables the rotor moving horizontally is generated by the flux generated from the stator winding coil.

In addition, although the rotor can be leveled accurately, in the case where minute vibrations or unbalance of force occurs, a displacement can be made left and right, and up and down, so that the driving axis of the piston contacting with the compressor is designed eccentrically with respect to the center axis in the opposite directions respectively so as to function as a guide for reducing the displacement resulting from the unbalance, and, in order to reduce the weight of the rotor, the rotor is configured of a structure forming rectangular depression at both portions adjacent to the center 223. In addition, if magnetic materials are used for the center 223 and support 224 which are placed between the front and back end of the permanent magnets and iron cores, the flux generated by the permanent magnets is leaked, so that non-magnetic materials are used

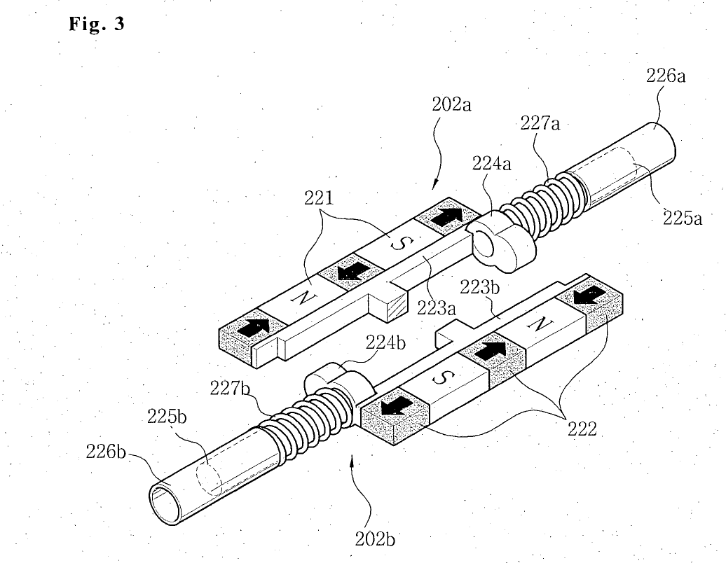

FIG. 3 shows an exploded perspective view of a rotor of the bi-directional operating compressor using a transverse flux linear motor according to the invention.

As shown in FIG. 3, exploding the rotor into two, i.e. a front and a rear, rotors 202a, 202b, the rotor comprises a plurality of permanent magnets connected to the rotor iron cores 221 for generating fluxes of different directions, a rotor center 223a, 223b having a pair of facing structures in which the permanent magnets 222 are connected to the rotor iron cores 221, rotor supports 224a, 224b connected to both ends of the center, and pistons 225a, 225b connected to one side of each supports 224a, 224b. In addition, a cylinder 226a, 226b compressing air in response to the reciprocating motion of the piston 225a, 225b is included, and the piston is inserted into the cylinder 226a, 226b when it is operating. A resonant spring 227a, 227b is placed, each end of which is fixed to one side of the support 224a, 224b and cylinder 226a, 226b respectively. The support 224a, 224b connected to the spring 227a, 227b is connected to the front and the rear rotor 202a, 202b eccentrically with respect to the driving axis of the piston, and the permanent magnets 222 of the rotor 202a, 202b are configured in a structure that can make high void flux by placing the permanent magnets to face the opposite poles each other. The arrows in the figure show the directions of the flux generated by the permanent magnets 222. At this point, the iron cores 221 are formed in the same size, and the permanent magnets 222 also formed in the same size.

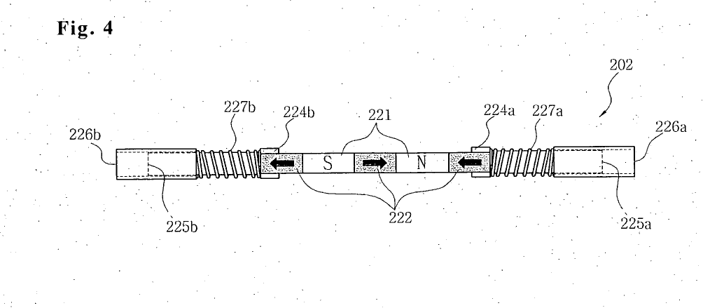

FIG. 4 shows a side view of the rotor of the bi-directional operating compressor using a transverse flux linear motor according to the invention.

As shown in FIG. 4, the rotor 202 has a plain type structure moving horizontally, left and right.

FIG. 5 shows a perspective view of a stator iron core of the bi-directional operating compressor using a transverse flux linear motor according to the invention.

As shown in FIG. 5, the stator iron core comprises a plurality of U-shape iron cores formed of a pillar and a support, and an upper iron core 211a is disposed in opposite relation to a lower iron core 211b, placing a polar pitch between the upper portion and lower portion as much as τₚ so as to generate forces to the same direction at the both voids by the flux of the rotor 202 and the flux of the stator 201. That is, the upper and lower stator iron cores 211a, 211b are arranged in parallel at 2τₚ intervals at the upper portion 211a and lower portion 211b respectively, and the upper stator iron core 211a and the lower stator iron core 211b are arranged left and right by a polar pitch of τₚ, so that the upper stator iron core 211a and the lower stator iron core 211b are offset by the polar pitch.

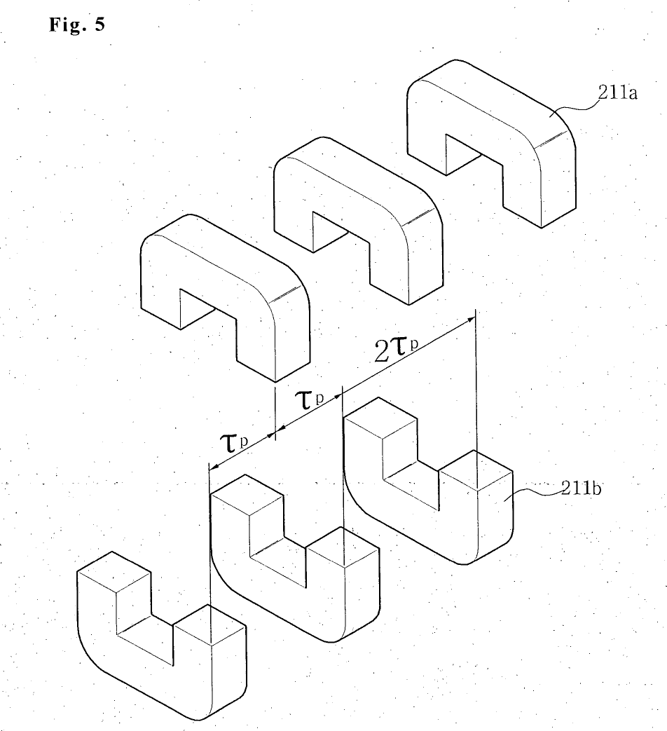

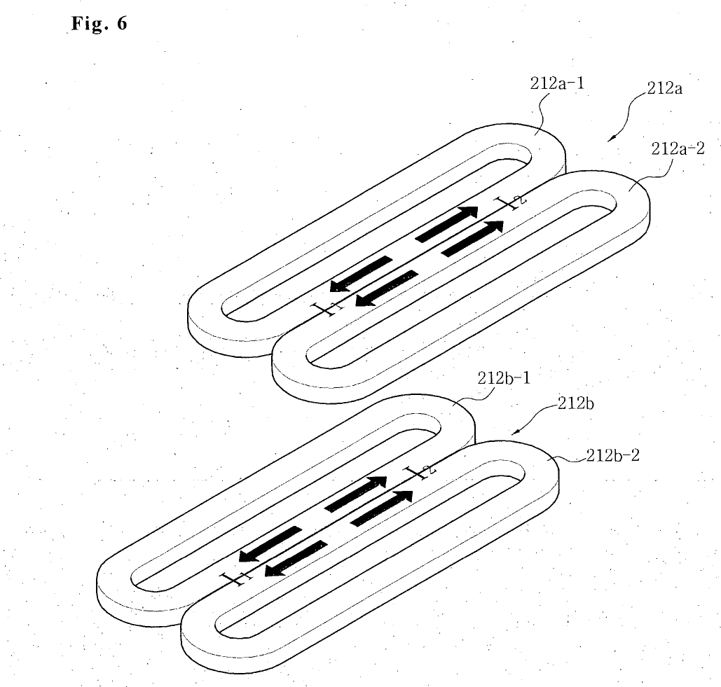

FIG. 6 shows a perspective view of a stator winding coil of the bi-directional operating compressor using a transverse flux linear motor according to the invention.

As shown in FIG. 6, winding coils are formed of two long circular cylinders, and the two circular winding coils are arranged to be neighbored each other. In addition, current I₁ flows through an upper winding coil 212a and a lower winding coil 212b in the same direction respectively, generating flux at the stator iron core. If current I₂ flows in the reverse direction, the direction of the flux changes to the opposite direction, so that the rotor 202 may move to the opposite direction reciprocally according to the direction of the current. As shown in FIG. 2, at the center hole of one circular winding coil 212a-1, 212b-1, pillars in one direction of the multiple stator iron cores 211a, 211b arranged in parallel are inserted, and, at the center hole of the other circular winding coil 212a-2, 212b-2, pillars in the other direction of the multiple stator iron cores 211a, 211b arranged in parallel are inserted.

Like this, when the pillars of the stator iron cores are inserted and installed at the centers of the circular winding coils 212a-1, 212a-2, 212b-1, and 212b-2, as shown in FIG. 2, a structure is formed, in which the contacting portion of the two circular winding coils 212a, 212b is supported by the support of the stator iron cores 211a, 211b, and the rotor 202 is placed on the border of the circular winding coils between the pillars of the stator iron cores. At this point, one pitch 2τₚ of the stator iron cores 211a, 211b arranged in parallel preferably corresponds to the length of two rotor iron cores and two permanent magnet.

FIG. 7 shows a descriptive view of a right side operation of the bi-directional operating compressor using a transverse flux linear motor according to the invention.

As shown in FIG. 7, when current I₁ flows through the stator winding coils 212a, 212b, fluxes, i.e. the S pole in the front and the N pole at the rear of the upper stator iron core 211a, and the N pole in the front and the S pole at the rear of the lower stator iron core 211b, are generated by the Ampere's main circuit law, and, by the interaction between the magnetic pole of the stator 201 and the magnetic pole of the rotor 202, if the directions of the magnetic poles are same, a repulsive force is generated, and if the directions of the magnetic poles are different, an attractive force is generated, so that a synthesized force Fₐ in the right direction is generated by the repulsive force between the N-N poles and the attractive force between the N-S poles.

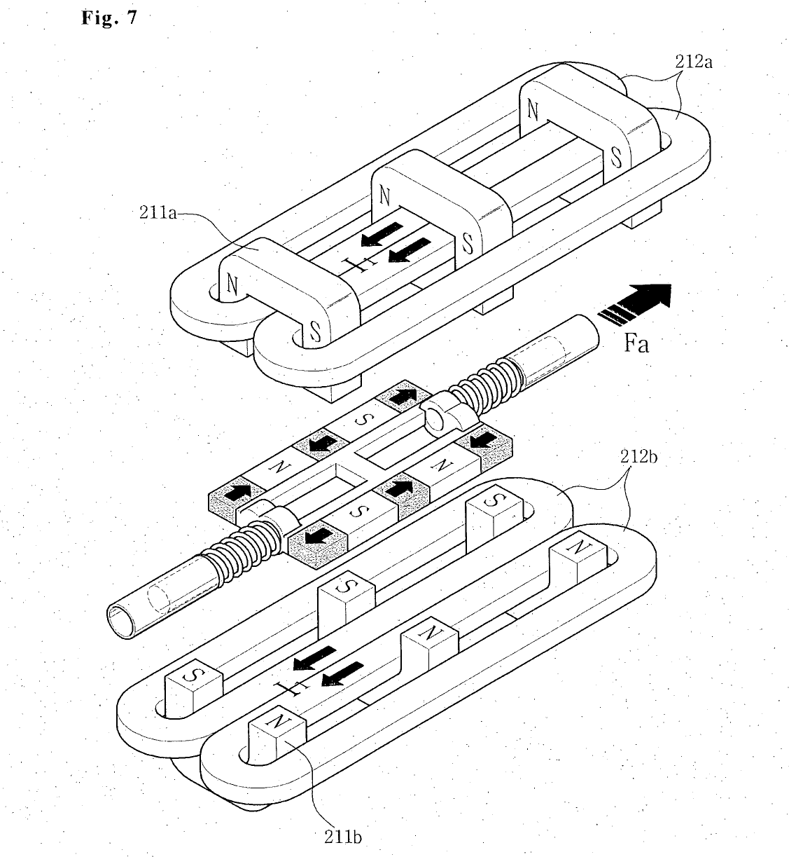

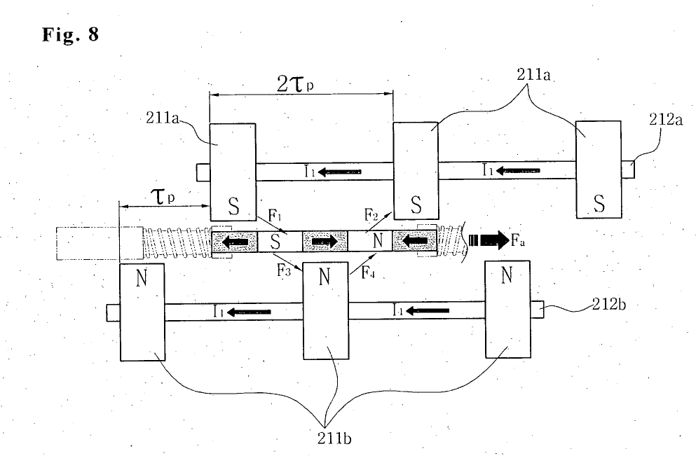

FIG. 8 shows power generation principles of the right side operation of the bi-directional operating compressor using a transverse flux linear motor according to the invention.

As shown in FIG. 8, from the view point of a two-dimensional drawing showing a front cross-section of the upper and lower portion, current flows through the stator winding coil 212a, 212b, and thus flux of the S pole is generated at the upper stator winding coil 211a and flux of the N pole is generated at the lower stator winding coil 211b. By the relationship with the rotor 202, a repulsive force F₁, F₄ of the S-S and the N-N, and an attractive force F₂, F₃ of the S-N and the N-S are acting, therefore a force Fₐ moving the whole compressor to the right begins to act.

FIG. 9 shows a descriptive view of a left side operation of the bi-directional operating compressor using a transverse flux linear motor according to the invention.

As shown in FIG. 9, if current I₂ flows in the reverse direction, the front end and the rear end of the upper stator iron core 211a become the N pole and the S pole respectively. By the interaction of the magnetic pole of the stator 201 and the magnetic pole of the rotor 202, if the directions of the magnetic poles are same, a repulsive force is generated, and, if the directions of the magnetic poles are different, an attractive force is generated, and thus a force F_{b} toward the left is generated by the repulsive force between the N-N poles and the attractive force between the N-S poles.

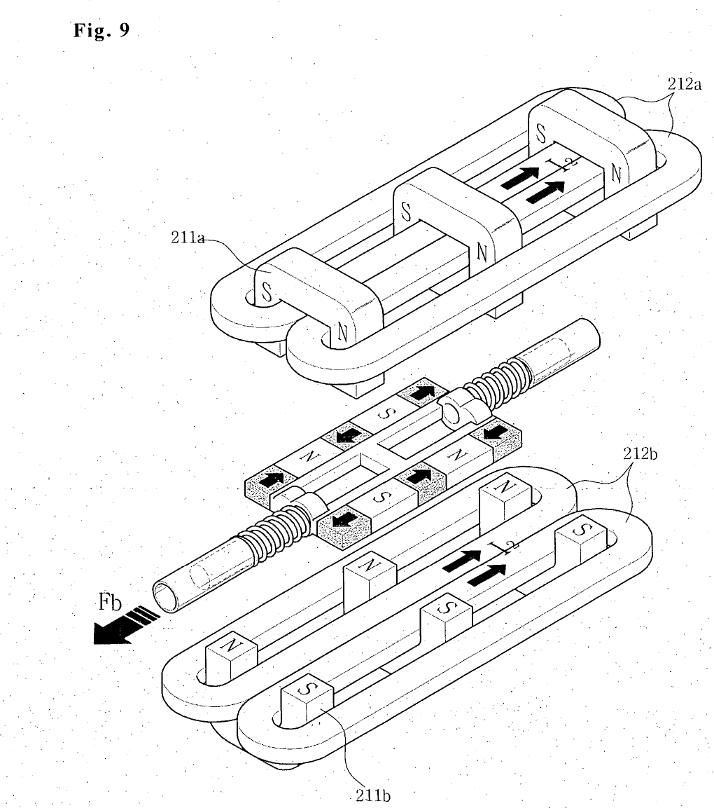

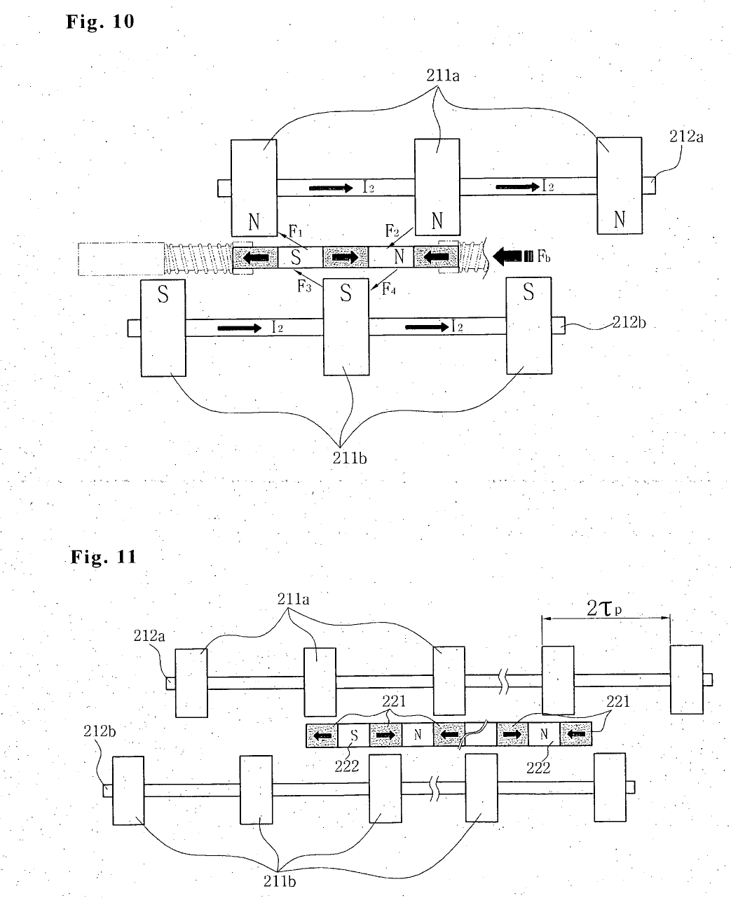

FIG. 10 shows power generation principles of the left side operation of the bi-directional operating compressor using a transverse flux linear motor according to the invention.

As shown in FIG. 10, from the view point of a two-dimensional drawing showing a front cross-section of the upper and lower portion, a repulsive force F₂, F₃ is acted on the portion where the attractive force is acted in FIG. 8, and an attractive force F₁, F₄ is generated at the portion where the repulsive force is acted in FIG. 8. That is, a force F_{b} having the same magnitude as and the different direction from that of FIG. 8 is acted, and thus the compressor can move to the opposite direction.

FIG. 11 shows a side view of a transverse flux linear motor having a plurality of rotor iron cores and stator iron cores according to the invention.

As shown in FIG. 11, from the view point of a two-dimensional drawing showing the front cross-section of the upper and lower portion, a plurality of rotor iron cores 221 and permanent magnets 222 are provided, and a plurality of stator iron cores 211a, 211b are applied as well, thereby enabling moving the rotor over multiple cycles, not for one cycle.

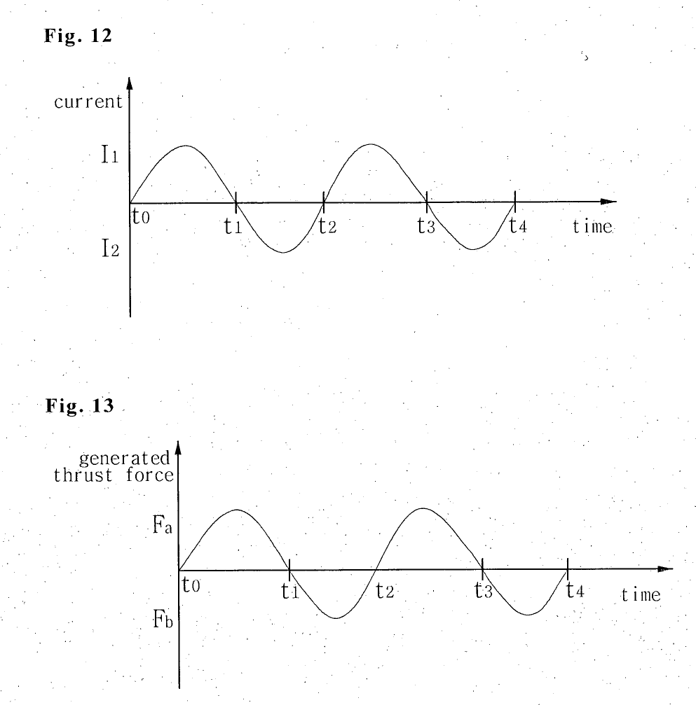

FIG. 12 shows a time-current characteristic graph of a rotor of a the transverse flux linear motor according to the invention, and FIG. 13 shows a time-generated thrust force characteristic graph of the rotor.

As shown in FIG. 12, if current having a strength of I₁ during a time period t₀-t₁ of the first ½ cycle and current I₂ having the same strength in the opposite direction during a time period t₁-t₂ of the other ½ cycle are applied, as shown in FIG. 13, a thrust force Fₐ of the rotor is generated for the time period t₀-t₁ of the first ½ cycle, and a thrust force F_{b} having the same strength in the opposite direction is generated for the time period t₁-t₂ of the other ½ cycle. The thrust force has the same polarity as the current, and the force Fₐ is generated by the current I₁, and the force F_{b} having the same strength in the opposite direction is generated by the current I₂.

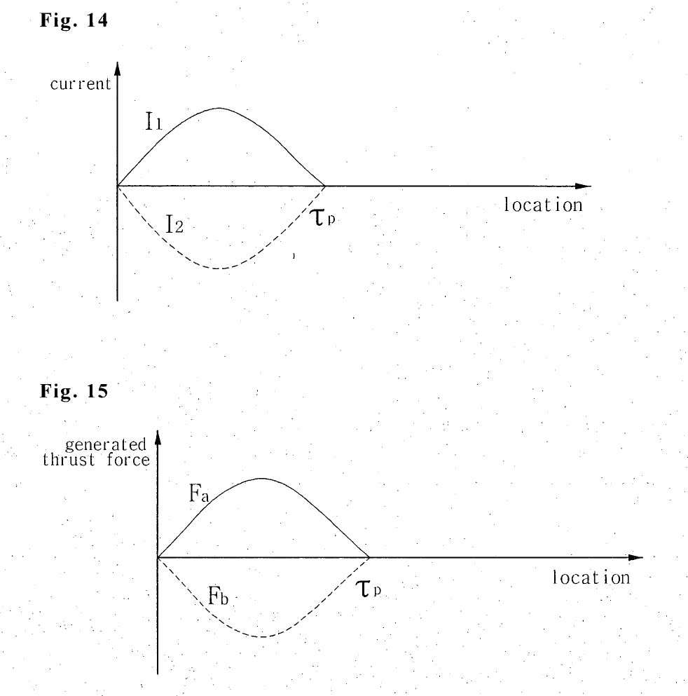

FIG. 14 shows a location-current characteristic graph of the rotor of a transverse flux linear motor according to the invention, and FIG. 15 shows a location-generated thrust force characteristic graph of the rotor.

As shown in FIG. 14, in the case where the current I₁ is applied during the time period 0-τₚ, a thrust force Fₐ is generated according to the location of the rotor as shown in FIG. 15, and, in the case where the current I₂ is applied, a thrust force F_{b} is generated.

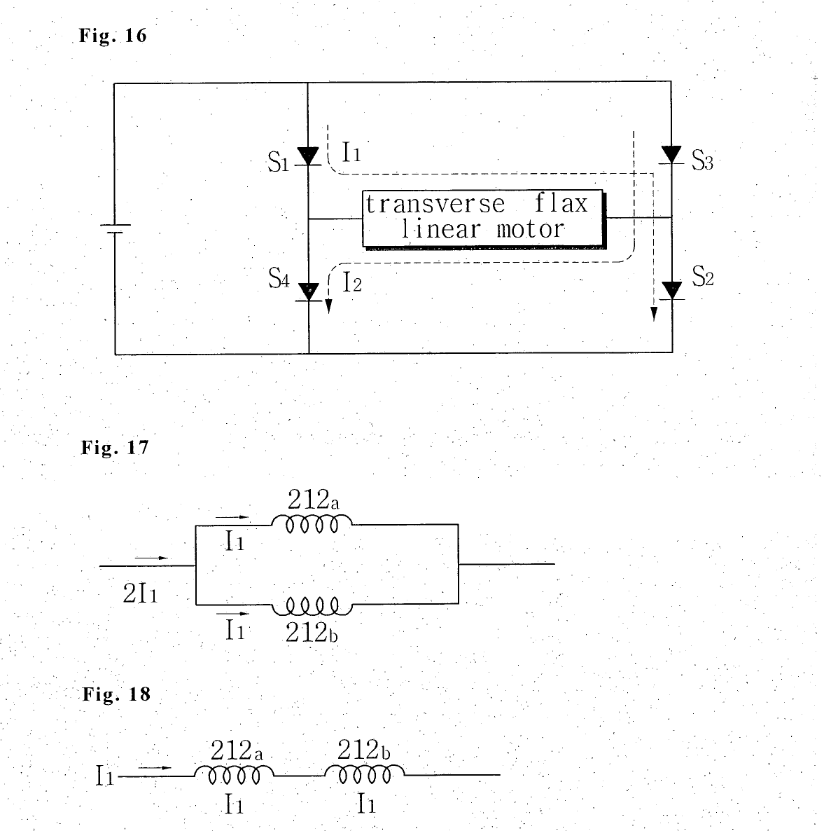

FIG. 16 shows a current supply circuit diagram of a transverse flux linear motor according to the invention.

As shown in FIG. 16, the current flowing through the upper winding coil 212a and the lower winding coil 212b flows in the same direction, and a force Fₐ is generated by conducting switch S₁ and S₂ and flowing current in the direction I₁. In the same manner, when the current flows in the opposite direction, a force F_{b} is generated by conducting switch S₃ and S₄ and flowing current in the direction I₂. Here, the switches S₁-S₄ are preferred using a semiconductor element capable of high speed switching.

FIG. 17 shows a circuit diagram of a two-element parallel configuration of a transverse flux linear motor according to the invention.

As shown in FIG. 17, the circuit is a two-element parallel circuit connecting an upper winding coil 212a and a lower winding coil 212b formed of a front 212a-1, 212b-1 and a rear 212a-2, 212b-2 winding coil respectively, which is suitable for low voltage and high current.

FIG. 18 shows a circuit diagram of a series configuration of a transverse flux linear motor according to the invention.

As shown in FIG. 18, the circuit is a series circuit connecting the upper winding coil 212a and the lower winding coil 212b, which is suitable for low voltage and high current.

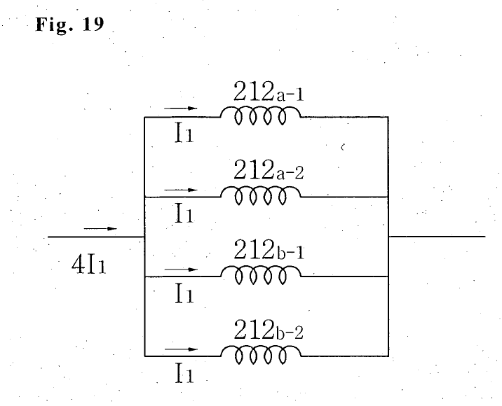

FIG. 19 shows a circuit diagram of a four-element parallel configuration of a transverse flux linear motor according to the invention.

As shown in FIG. 19, the circuit is a four-element parallel circuit connecting a front, a rear, an upper and a lower winding coils 212a-1, 212a-2, 212b-1, 212b-2, which is suitable for lower voltage and higher current than the circuit in FIG. 17.

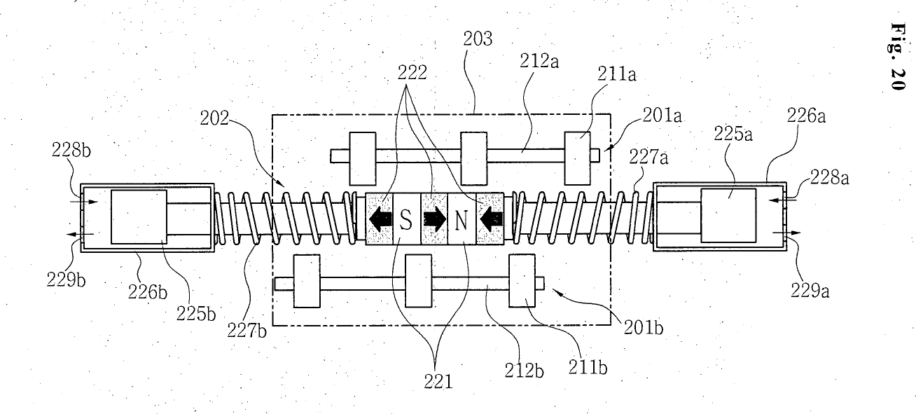

FIG. 20 shows a descriptive view of a compressor formed with a bi-directional operating piston-resonant spring and a transverse flux linear motor according to the invention.

As shown in FIG. 20, a bi-directional operating compressor using a transverse flux linear motor is provided with a rotor 202 located between two, i.e. an upper and a lower, stators 201a, 201b, a stator formed of a winding coil 212a, 212b and a stator iron core 211a, 211b respectively. The rotor 202 including a rotor iron core 221, a permanent magnet 222 and a piston 225a, 225b is connected to a resonant spring 227a, 227b at both sides. When the left side is compressed, a left outflow valve 229b and a right inflow valve 228a are opened at the same time, and, when the compression is processed in the opposite direction, a right outflow valve 229a is opened to compress and the inflow valve 228b is opened on the left.

In addition, FIG. 20 shows a compressor having a piston 225a, 225b and a cylinder 226a, 226b at both sides of the transverse flux linear motor, which provides a high-efficiency high-power linear compressor using a resonant mechanism between a electro-magnet, a piston road, and the spring, by placing springs 227a, 227b between the compressors placed at both sides and the transverse flux linear motor located at the center.

According to the invention of the above configuration, since the invention is basically based on a linear system, the structure is simple and the maintenance cost can be reduced, compared with a system using a rotational motor and a power transmission device in order to generated linear power.

In addition, compared with a compressor operating uni-directionally, although a linear motor having the same capacity is used, since compressing and inflowing actions are performed at the same time when the rotor moves left and right, the compressor of the invention can do almost twice as much work. At the same time, in the transverse flux linear motor, the exact location and torque value can be adjusted, and a variable outflow method which can control the separation of an electric circuit and a magnetic circuit is used, thereby reducing the capacity and the size. Therefore, also the thrust force which can be obtained from the a certain capacity is twice or more than that of a conventional linear motor, so that, if a bi-directional operating motor and a traverse flux linear motor are used together practically, four times or more thrust force can be obtained from the same size of a compressor theoretically.

In addition, according to the invention, compared with a conventional linear motor, a superior thrust force can be obtained from the same volume, so that the volume of a motor can be minimized when the invention is applied to a compressor.

In addition, according to the invention, high power can be obtained, and thus the amount of the iron core and the winding wire is decreased, thereby reducing material costs.

In addition, according to the invention, the weight of the motor can be reduced by forming rectangular depressions at both portions adjacent to the center of the rotor.

In addition, according to the invention, the resonance characteristic of a system is used, in which, by placing resonance springs at both sides of the rotor, the springs absorb and emit the inertia force generated by compressing and releasing actions, i.e. moving to the left and right, thereby minimizing the loss of energy generated by the motor.

In addition, according to the invention, the operating axis of the piston is designed eccentrically with respect to the center axis, so that rotation along the axis is not occurred and the void of a motor can be maintained uniformly, thereby generating consistent power and reducing vibration.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A bi-directional operating compressor using a transverse flux linear motor, the compressor comprising:
a pair of stators including a plurality of U-shape upper stator iron cores and a plurality of U-shape lower stator iron cores, the upper and lower stator cores being arranged in parallel at regular intervals respectively in such a manner that the individual stator iron cores are spaced apart from each other by a certain desired polar pitch, and the upper stator iron cores and the lower iron cores face each other and are offset by the polar pitch, and a pair of neighboring circular winding coils, both of the pillars of the stator iron core being inserted into the centers of the winding coils;
a rotor placed between a pair of stators, the rotor including a plurality of permanent magnets connected to iron cores of a certain length so as to generate fluxes of different directions, a rotor center installed between a pair of structures, the permanent magnets and the rotor iron cores being connected such that the structures are placed to face each other, a pair of supports connected to both sides of the center, and a pair of pistons connected to one side of the support respectively; and
a pair of cylinders provided facing the pistons at both side ends of the rotor, for compressing air in response to the reciprocating motion of the pistons.

2. The compressor according to claim 1, further comprising a spring fixed at both ends thereof to the support of the rotor and one side of the cylinder.

3. The compressor according to claim 1, wherein the rotor has rectangular depressions formed at both portions adjacent to the center thereof.

4. The compressor according to any one of claim 1 to 3, wherein the operating axis of the piston at both ends of the rotor is eccentric with respect to the center axis.
